(19) United States
(12) Patent Application Publication
(10) Pub. No.: US 2023/0385019 A1
(43) Pub. Date: Nov. 30, 2023

(54) Custom Audio Puzzle

(71) Applicant: Feo Products LLC, Pflugerville, TX (US)

(72) Inventor: Lewis Caleb Livingston, Pflugerville, TX (US)

(73) Assignee: Feo Products LLC, Pflugerville, TX (US)

(21) Appl. No.: 18/319,040

(22) Filed: May 17, 2023

Related U.S. Application Data
(60) Provisional application No. 63/365,070, filed on May 20, 2022.

(51) Int. Cl. G06F 3/16; H04R 5/04; H04R 1/10; A63F 9/24

(52) U.S. Cl. CPC G06F 3/165; H04R 5/04; H04R 1/1041; A63F 9/24; H04R 2420/07; H04R 2420/09; A63F 2009/2402; A63F 2009/247; A63F 9/0098

(57) ABSTRACT

This disclosure describes an apparatus and method of an embodiment of an invention that is custom audio puzzle. This embodiment of the apparatus includes: an audio board 306 with a processor, memory, and storage; switches 308 used as triggers to play selected custom audio files; an audio speaker 312; a power supply 304; communications circuitry to upload audio files to the processor, memory, and storage; software to allow the user to easily tie the audio files to the various switches used as triggers.

### CROSS REFERENCE TO RELATED APPLICATIONS

This application claims priority and the benefits of the earlier filed Provisional Application USAN 63365070, filed May 20, 2022, which is incorporated by reference for all purposes into this specification.

### TECHNICAL FIELD

This disclosure relates to audio puzzles. More specifically, this disclosure relates to custom audio puzzles.

### BACKGROUND ART

Puzzles are a popular means for providing entertainment and education through tactile interaction for children and adults alike. These benefits can be enhanced when combined with the engagement of additional senses, especially that of sound.

Many sound puzzles are currently available on the market. Users can interact with the puzzle and trigger corresponding audio files. Typically, these puzzles are built utilizing a processor such as an application specific System on a Chip (SOC). One skilled in the art will appreciate that other types of processors may be used as well. A base plate contains the power supply, processor, speaker, triggers such as magnetic switches or photoresistors, and a frame to receive the pieces. A face plate holds the pieces and any associated graphic details.

While this method is efficient for mass production, it is not an economically viable solution for small scale/custom applications. Processors such as Application specific SoC's are costly to design and require large volumes to generate positive returns.

A large market currently exists for small production run or custom puzzles. A need exists to provide small production run or custom sound puzzles with integrated audio content which can be easily loaded by the manufacturer or customer using standard, readily available hardware, and software to limit technical expertise requirements in a compact form.

The current technology is described in these references:

PLT1: KR200211802Y1. Title: Puzzle device capable of playing back and recording sound signals. A customer or manufacturer can load audio content onto the puzzle by use of a microphone. In contrast, however, in this disclosure, the user uploads audio files to the sound board which enables higher quality audio input as well as a broader range of audio files. This reference is incorporated by reference for all purposes into this disclosure.

PLT2: JP3001830U. Title: Jigsaw puzzle with sound generator. This disclosure describes a puzzle with prerecorded audio files on a tape or CD. In contrast, however, the customer with this disclosure can directly load their own audio files onto the puzzle through a port which does not require a separate hinged door. CD and tape players are inherently bulkier than a SOC with memory thus allowing the user to reduce the size of the final application. This reference is incorporated by reference for all purposes into this disclosure.

PLT3: KR200367880Y1. Title: Device of a sound puzzle. This disclosure describes a device allowing a multitude of polygonal pieces to be placed within a frame. Each piece having a unique circuit which will connect a unique voice chip to ground when the associated piece is placed in the hole thus completing the circuit. The patent also describes a device where the pieces are all a common shape and can be loaded into the polygonal hole. This patent makes mention of voice chips but does not make any claims regarding the ability of the customer or a novice to load audio content onto the device. In contrast, however, in this disclosure, the pieces do not contain circuitry and can be made in a wide variety of shapes. Additionally, a customer or novice can load audio content onto the system using readily available hardware and software. This reference is incorporated by reference for all purposes into this disclosure.

### Technical Problem

Audio puzzles currently available on the market require significant investment and expertise to develop and do not allow for custom content to be loaded onto the device. Existing patents are limited in potential quality, compact format, or require incremental housing features to access.

### Solution to Problem

This disclosure provides a unique and distinct way for audio content to be loaded onto a custom audio puzzle. What is different and new is the method by which audio content is loaded onto the device. In this disclosure, audio content is loaded onto the device through a standard cable connection interface and port or through an SD card and slot in line with onboard memory, processors, and software. Additionally, common wireless communication methods such as Bluetooth can also be used.

### Advantageous Effects of Invention

The current disclosure has one or more distinguishing features not found in the above references: (a) this disclosure uses accessible ports or wireless communication to load audio content which does not require incremental housing and reduces size and bulk; (b) this disclosure does not require the use of a microphone to load audio content which limits the quality and variety of audio content which can be loaded onto the device; (c) the inclusion of appropriate software and hardware allow for novice users to load audio content in a low cost format when compared to other devices.

### SUMMARY OF INVENTION

This disclosure describes an apparatus and method of an embodiment of an invention that is custom audio puzzle. This embodiment of the apparatus include: an audio board with a processor, memory, and storage; switches used as triggers to play selected custom audio files; an audio speaker; a power supply; communications circuitry to upload audio files to the processor, memory, and storage; software to allow the user to easily tie the audio files to the various switches used as triggers.

The above embodiment of the invention may include one or more of these additional embodiments that may be combined in all combinations with the above embodiment. One embodiment of the invention describes where the communications circuitry uses a USB port. One embodiment of the invention describes where the communications circuitry uses Bluetooth. One embodiment of the invention describes where the switches are tactile switches. One embodiment of the invention describes where the switches are magnetic switches. One embodiment of the invention describes where the switches are photoresistor switches.

### BRIEF DESCRIPTION OF DRAWINGS

The drawings accompanying and forming part of this specification are included to depict certain aspects of the disclosure. A clearer impression of the disclosure, and of the components and operation of systems provided with the disclosure, will become more readily apparent by referring to the exemplary, and therefore non-limiting, embodiments illustrated in the drawings, where identical reference numerals designate the same components. Note that the features illustrated in the drawings are not necessarily drawn to scale. The patent or application file may contain at least one drawing executed in color. Copies of this patent or patent application publication with color drawing(s) will be provided by the Office upon request and payment of the necessary fee. The following is a brief description of the accompanying drawings:

FIG. 1 illustrates an embodiment of the first layer of the faceplate, a slot for the on/off switch, the slots for the pieces and the corresponding pieces, and a screen for the speaker.

FIG. 2 illustrates an embodiment of the second layer of the faceplate, the switch pins, the battery holder, and a compartment for the speaker.

FIG. 3 illustrates an embodiment of the first layer of the base plate and the wiring schematic for the electronic components.

FIG. 4 illustrates an embodiment of the micro-USB port cutout in the sidewall.

FIG. 5 illustrates an embodiment of the second layer of the base plate and the battery holder access panel.

FIG. 6 illustrates an alternative embodiment of FIG. 5 where the second layer of the base plate in which the battery holder access panel is replaced with a cutout for a battery holder and the micro-USB port cutout is replaced with an access panel.

FIG. 7 illustrates an alternative embodiment of FIG. 3 wiring schematic where the audio board is recessed into the device and is accessed through the panel as described in FIG. 6.

### DESCRIPTION OF EMBODIMENTS

The disclosed embodiments should describe aspects of the disclosure in sufficient detail to enable a person of ordinary skill in the art to practice the invention. Other embodiments may be utilized, and changes may be made without departing from the disclosure. The following detailed description is not to be taken in a limiting sense, and the present invention is defined only by the included claims.

Specific implementations shown and described are only examples and should not be construed as the only way to implement or partition the present disclosure into functional elements unless specified otherwise in this disclosure. A person of ordinary skill in the art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Benefits, other advantages, and solutions to problems are shown and described with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In the following description, elements, circuits, functions, and devices may be shown in block diagram form in order not to obscure the present disclosure in unnecessary detail. And block definitions and partitioning of logic between various blocks are exemplary of a specific implementation. It will be readily apparent to a person of ordinary skill in the art that the present disclosure may be practiced by numerous other partitioning solutions. A person of ordinary skill in the art would understand that information and signals may be represented using any of a variety of technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, where the bus may have a variety of bit widths and the present disclosure may be implemented on any number of data signals including a single data signal.

The illustrative functional units include logical blocks, functions, modules, circuits, and devices described in the embodiments disclosed in this disclosure to emphasize their implementation independence more particularly. The functional units may be implemented or performed with a general-purpose processor, a special purpose processor, a Digital Signal Processor (DSP), an Application Specific Integrated Circuit (ASIC), a Field Programmable Gate Array (FPGA), System on a Chip (SoC), or other programmable logic device, discrete gate or transistor logic, discrete hardware components, or any combination thereof designed to perform the functions described in this disclosure. A general-purpose processor may be a microprocessor, any conventional processor, controller, microcontroller, or state machine. A general-purpose processor may be considered a special purpose processor while the general-purpose processor is configured to fetch and execute instructions (e.g., software code) stored on a computer-readable medium such as any type of memory, storage, and/or storage devices. A processor may also be implemented as a combination of computing devices, such as a combination of a DSP and a microprocessor, a plurality of microprocessors, one or more microprocessors in conjunction with a DSP core, or any other such configuration.

In addition, the illustrative functional units described above may include software, programs, or algorithms such as computer readable instructions that may be described in terms of a process that may be depicted as a flowchart, a flow diagram, a structure diagram, or a block diagram. The process may describe operational acts as a sequential process, many acts can be performed in another sequence, in parallel, or substantially concurrently. Further, the order of the acts may be rearranged. In addition, the software may comprise one or more objects, agents, threads, lines of code, subroutines, separate software applications, two or more lines of code or other suitable software structures operating in one or more software applications or on one or more processors. The software may be distributed over several code segments, modules, among different programs, and across several memory devices. Similarly, operational data may be identified and illustrated in this disclosure within modules and may be embodied in any suitable form and organized within any suitable data structure. The operational data may be collected as a single data set or may be distributed over different locations including over different storage devices. Data stated in ranges include each and every value within that range.

Elements described in this disclosure may include multiple instances of the same element. These elements may be generically indicated by a numerical designator (e.g., 110) and specifically indicated by the numerical indicator followed by an alphabetic designator (e.g., 110A) or a numeric indicator preceded by a “dash” (e.g., 110-1). For ease of following the description, for the most part, element number indicators begin with the number of the drawing on which the elements are introduced or most discussed. For example, where feasible elements in Drawing 1 are designated with a format of 1xx, where 1 indicates Drawing 1 and xx designates the unique element.

Any reference to an element in this disclosure using a designation such as “first,” “second,” and so forth does not limit the quantity or order of those elements, unless such limitation is explicitly stated. Rather, these designations may be used in this disclosure as a convenient method of distinguishing between two or more elements or instances of an element. A reference to a first and second element does not mean that only two elements may be employed or that the first element must precede the second element. In addition, unless stated otherwise, a set of elements may comprise one or more elements.

Reference throughout this specification to “one embodiment”, “an embodiment” or similar language means that a particular feature, structure, or characteristic described in the embodiment is included in at least one embodiment of the present invention. Appearances of the phrases “one embodiment”, “an embodiment” and similar language throughout this specification may, but do not necessarily, all refer to the same embodiment.

In the following detailed description, reference is made to the illustrations, which form a part of the present disclosure, and in which is shown, by way of illustration, specific embodiments in which the present disclosure may be practiced. These embodiments are described in sufficient detail to enable a person of ordinary skill in the art to practice the present disclosure. However, other embodiments may be utilized, and structural, logical, and electrical changes may be made without departing from the true scope of the present disclosure. The illustrations in this disclosure are not meant to be actual views of any device or system but are merely idealized representations employed to describe embodiments of the present disclosure. And the illustrations presented are not necessarily drawn to scale. And elements common between drawings may retain the same or have similar numerical designations.

It will also be appreciated that one or more of the elements depicted in the drawings or figures can also be implemented in a more separated or integrated manner, or even removed or rendered as inoperable in certain cases, as is useful in accordance with a particular application. Additionally, any signal arrows in the drawings or figures should be considered only as exemplary, and not limiting, unless otherwise specifically noted. The scope of the present disclosure should be determined by the following claims and their legal equivalents.

As used in this disclosure, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus. Furthermore, the term “or” as used in this disclosure is generally intended to mean “and/or” unless otherwise indicated. For example, a condition A or B is satisfied by any one of the following: A is true (or present) and B is false (or not present); A is false (or not present) and B is true (or present); and both A and B are true (or present). As used in this disclosure, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description in this disclosure, the meaning of “in” includes “in” and “on” unless the context clearly dictates otherwise.

The claims following this written disclosure are expressly incorporated into the present written disclosure, with each claim standing on its own as a separate embodiment. This disclosure includes all permutations of the independent claims with their dependent claims. Further, additional embodiments capable of derivation from the independent and dependent claims that follow are also expressly incorporated into the present written description.

To aid any Patent Office and any readers of any patent issued on this disclosure in interpreting the included claims, the Applicant(s) wish to note that they do not intend any of the appended claims or claim elements to invoke 35 U.S.C. 112(f) (previously 35 U.S.C. 112(6)) unless the words “means for” or “step for” are explicitly used in that claim. Additionally, if any elements are specifically recited in means-plus-function format, then those elements are intended to be construed to cover the corresponding structure, material, or acts described in this disclosure or additional equivalents in accordance with 35 U.S.C. 112(f) (previously 35 U.S.C. 112(6)).

This disclosure describes a device that allows for custom audio content to be easily loaded onto a custom audio puzzle. To load audio content a user accesses the memory through a port. Loading pieces into the puzzle activates the magnetic, tactile, or photoresistor switches. A signal is sent to the logic unit which then pulls the appropriate audio file from memory and plays it through the speaker.

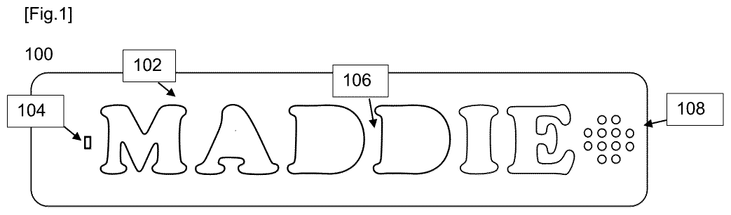

FIG. 1 illustrates an embodiment 100 of the first layer 102 of the faceplate according to this embodiment of the present disclosure. The faceplate in this example is made from a single piece of 0.125″ plywood. One skilled in the arts will appreciate that other materials may be used. A laser cutting device or other suitable cutting device is deployed to cut a slot 104 of appropriate size in the faceplate to provide access to the on/off switch for the power supply. The puzzle pieces 106 couple within their corresponding slots. In this embodiment of the disclosure, a laser cutter is used to cut the letters from the faceplate. The offcuts are then used as pieces and fit into the corresponding slots. A screen 108 for the speaker which is also created through cutouts by the laser cutter.

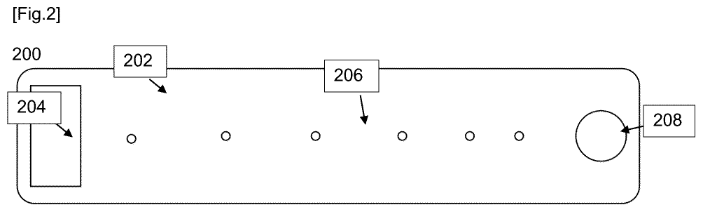

FIG. 2 illustrates an embodiment 200 of the second layer 202 of the faceplate. The faceplate in this embodiment is composed of 4 elements. The switch pins, the battery holder, and a compartment for the speaker. The second layer 202 of the faceplate which is made of a single piece of 0.125″ plywood. One skilled in the art will appreciate that other materials may be used. This layer 202 is attached to the first layer 102 of the faceplate with an adhesive or other coupling techniques known in the arts or created in the future. The battery holder 204 has a cutout made into this layer 202 of the faceplate. As noted elsewhere in this disclosure, the battery holder access can also be accomplished through an access panel. The switch pins 206 protrude through this layer of the faceplate. The pins can also be constructed using dowels. Corresponding holes are cut into this layer 202 of the faceplate to allow the pins to protrude through the faceplate such that the puzzle pieces may make contact with the pins. The speaker battery compartment 208 is in this layer of the faceplate.

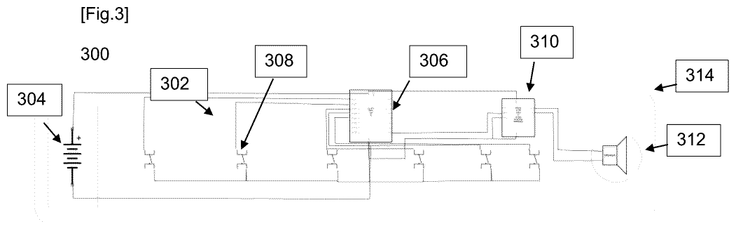

FIG. 3 illustrates an embodiment 300 with the first layer of the base plate and the wiring schematic for the electronic components. It is composed of 7 elements. The first layer 302 can be constructed on a single piece of plywood or on the reverse side of the 2nd layer of the face plate with the addition of sidewalls. One skilled in the arts will appreciate that other materials may be used. The battery holder or power supply 304, in this embodiment, uses 2 AAA batteries in parallel to achieve 3 v. One skilled in the arts will appreciate that other batteries and other power supplies may be used. The positive lead from the battery holder is wired to the audio board's VIN pad with 30 AWG wire. The negative lead is soldered to the audio boards ground pad. The audio board 306, in one embodiment, uses a micro-USB port, processor, on board memory, and software to facilitate the loading of the audio files and assigning them to the trigger mechanism. One skilled in the arts will appreciate that other circuitry may be used. The audio board 306 additionally includes communication circuitry that may include a USB interface and/or a wireless interface that includes a standard wireless protocol such as Bluetooth. The communications circuitry may be in the form a separate device, separate circuitry, or included into the processor. The audio board should be affixed to the appropriate layer of the face or back plates with adhesives, silicon, epoxy, screws, or other compatible affixing techniques. The board should be placed such that the micro-USB port protrudes through the port cut into the sidewall as illustrated in the drawing. As noted elsewhere in this disclosure, the USB port can be accessed through an access panel. The switches 308, in one embodiment, are wired to the corresponding trigger I/O pins with 30 AWG wire. One skilled in the art will appreciate that other types of electrical connections may be used. The switches can be magnetic, tactile, photoresistor switches, or other compatible types of switches. In one embodiment, the remaining wire lead is used to solder the switch to the ground pad on the audio board. Alternatively, the ground leads may be wired to the next nearest switches ground wire with the last ground lead soldered to the audio boards ground pad. The switches should be affixed to the last layer of the baseplate or the reverse side of the 2nd layer of the faceplate with adhesive, silicon, epoxy, or other appropriate coupling methods. Individual switches are placed in appropriate locations for each of the pieces in the puzzle. The switches 308 operate as the triggers for the playing the specified custom audio. Amplifier 310 is in this embodiment a 2.5 W Class D amplifier. One skilled in the art will appreciate that other types of sound amplifying techniques can be used. In one embodiment, the LAC pad on the audio board is coupled to the AIN+pad on the amplifier with 30 AWG wire. In one embodiment, the AIN−pad and the amplifiers ground pad are soldered to the ground pad of the audio board with 30 AWG wire. One skilled in the art will appreciate that other types of electrical connections may be used. The amplifiers VCC pad is wired to the VIN pad on the audio board. This element is attached to the 2nd layer of the baseplate with adhesive or other coupling techniques. Speaker 312 in this embodiment is an 8 ohm 0.25 W speaker. The speakers positive lead is soldered to the VO+ lead from the amplifier and the negative lead is soldered to the VO− pad on amplifier 310. The speaker 312 is placed with in the compartment cut out of the various plate layers. Adhesive, silicon, epoxy, or other affixing compounds are used to fix the speaker in position. A bead of the adhesive, silicon, epoxy, or other compound is placed around the circumference of the compartment and on the reverse side of the speaker from the speaker cone to form an airtight seal. The height of the sidewall 314 of the baseplate should allow for clearance of the battery holder, speaker, amplifier, and switches as needed. In this embodiment the sidewall is 0.125″ thick and was cut from a laser cutter. The sidewall 314 is attached to the 2nd layer of the faceplate with adhesive or coupling techniques.

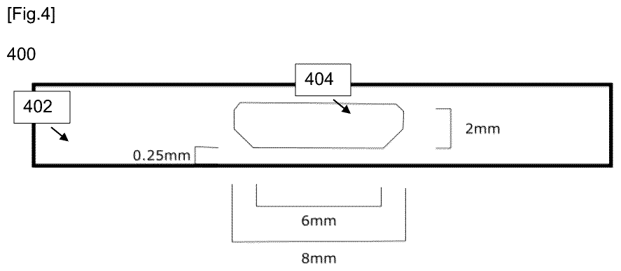

FIG. 4 illustrates embodiment 400 with the micro-USB port cutout 400 in the sidewall 402 of the baseplate (not shown). The height of the baseplate should allow for clearance of the battery holder, speaker, amplifier, and switches as needed. In this embodiment the sidewall 402 is 0.125″ thick and was cut from a laser cutter. The access port 404 is for the Micro-USB port. In this embodiment, the access port is cut from the sidewall with a laser curter. The Micro-USB port which is attached to the audio board as defined earlier is positioned such that the female Micro-USB port protrudes through the hole cut into the sidewall. As noted elsewhere in this disclosure, the port cutout can be replaced with an access panel.

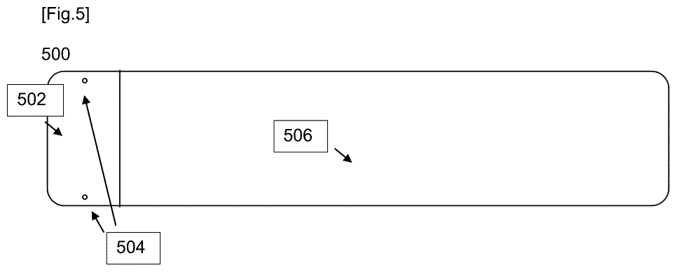

FIG. 5 illustrates an embodiment of the second layer 500 of the base plate and the battery holder access panel. The base plate cover 502 for the battery holder is a cut out of the 2^{nd} layer of the base plate in this embodiment. Screws 504 attach the base plate cover 502 for the battery holder to the first layer of the base plate. One skilled in the art will appreciate that other coupling techniques can be used. The 2^{nd} layer of the base plate 506, in this embodiment, is constructed with 0.25″ plywood. One skilled in the arts will appreciate that other materials may be used. This layer is attached to the first layer of the baseplate with adhesive or other coupling techniques.

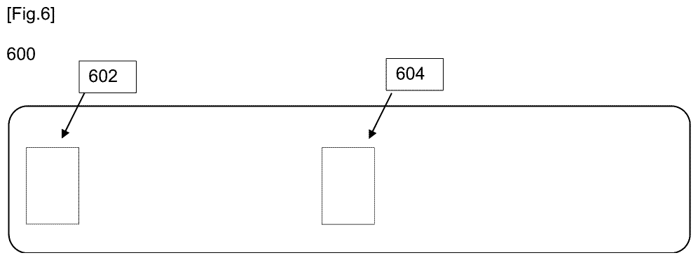

FIG. 6 illustrates an alternative embodiment 600 of the above embodiment 500 of FIG. 5. The battery cutout 602 is cut from the 2^{nd} layer of the base plate in this embodiment. The micro-USB access panel 604 is also cut from the 2^{nd} layer of the base plate in this embodiment and a plastic cover is attached to the base plate with screws. One skilled in the arts will appreciate that other coupling techniques may be used.

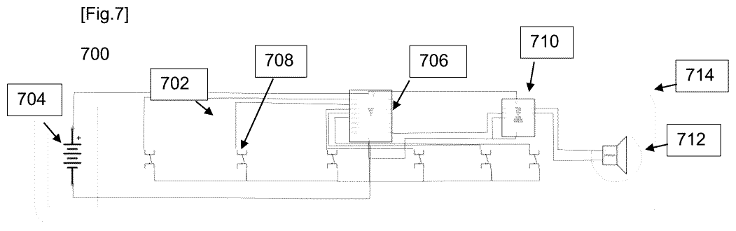

FIG. 7 illustrates an alternative embodiment 700 of embodiment 300 of FIG. 3. Embodiment 700 includes the first layer 702, the battery holder or power supply 704, the audio board 706, switches 708, amplifier 710, speaker 712, and sidewall 714. In this embodiment, the audio board 706 is recessed into a cavity created between the face plate and base plate. The audio board 706 is accessible through the access panel as previously described.

While the present disclosure has been described in this disclosure regarding certain illustrated and described embodiments, those of ordinary skill in the art will recognize and appreciate that the present disclosure is not so limited. Rather, many additions, deletions, and modifications to the illustrated and described embodiments may be made without departing from the true scope of the invention, its spirit, or its essential characteristics as claimed along with their legal equivalents. In addition, features from one embodiment may be combined with features of another embodiment while still being encompassed within the scope of the invention as contemplated by the inventor. The described embodiments are to be considered only as illustrative and not restrictive. All changes which come within the meaning and range of equivalency of the claims are to be embraced within their scope. Disclosing the present invention is exemplary only, with the true scope of the present invention being determined by the included claims.

1. An apparatus that is a custom audio puzzle, comprising:
an audio board with a processor, memory, and storage;
switches used as triggers to play selected custom audio files;
an audio speaker;
a power supply;
communications circuitry to upload audio files to the processor, memory, and storage;
software to allow the user to easily tie the audio files to the various switches used as triggers.

2. The claim according to claim 1 where the communications circuitry uses a USB port.

3. The claim according to claim 1 where the communications circuitry uses Bluetooth.

4. The claim according to claim 1 where the switches are tactile switches.

5. The claim according to claim 1 where the switches are magnetic switches.

6. The claim according to claim 1 where the switches are photoresistor switches.

7. A method to make an apparatus that is custom audio puzzle, comprising:
providing an audio board with a processor, memory, and storage;
coupling switches used as triggers to play selected custom audio files to the audio board;
coupling an audio speaker to the audio board;
coupling a power supply to the audio board;
coupling communications circuitry to upload audio files to the processor, memory, and storage to the audio board;
providing software to the processor, memory, and storage to allow the user to easily tie the audio files to the various switches used as triggers.

8. The claim according to claim 7 where the communications circuitry uses a USB port.

9. The claim according to claim 7 where the communications circuitry uses Bluetooth.

10. The claim according to claim 7 where the switches are tactile switches.

11. The claim according to claim 7 where the switches are magnetic switches.

12. The claim according to claim 7 where the switches are photoresistor switches.

13. A method to use an apparatus that is custom audio puzzle, comprising:
providing an audio board with a processor, memory, and storage;
providing switches used as triggers to play selected custom audio files;
providing an audio speaker;
providing a power supply;
uploading audio files to the processor, memory, and storage through communications circuitry;
tying the audio files to the various switches used as triggers using software to allow the user to easily make the change.

14. The claim according to claim 13 where the communications circuitry uses a USB port.

15. The claim according to claim 13 where the communications circuitry uses Bluetooth.

16. The claim according to claim 13 where the switches are tactile switches.

17. The claim according to claim 13 where the switches are magnetic switches.

18. The claim according to claim 13 where the switches are photoresistor switches.

19. A non-transitory program storage device readable by a computing device that tangibly embodies a program of instructions executable by the computing device to perform a method to use an apparatus that is custom audio puzzle, comprising:
providing an audio board with a processor, memory, and storage;
providing switches used as triggers to play selected custom audio files;
providing an audio speaker;
providing a power supply;
uploading audio files to the processor, memory, and storage through communications circuitry;
tying the audio files to the various switches used as triggers using software to allow the user to easily make the change.

20. The claim according to claim 19 where the communications circuitry uses a USB port.

21. The claim according to claim 19 where the communications circuitry uses Bluetooth.

22. The claim according to claim 19 where the switches are tactile switches.

23. The claim according to claim 19 where the switches are magnetic switches.

24. The claim according to claim 19 where the switches are photoresistor switches.

25. An apparatus that is custom audio puzzle, comprising:
an audio board with a processor, memory, and storage;
switch means for switching used as triggers to play selected custom audio files;
an audio speaker;
a power supply;
communications circuitry to upload audio files to the processor, memory, and storage;
software to allow the user to easily tie the audio files to the various switches used as triggers.

26. The claim according to claim 25 where the communications circuitry uses a USB port.

27. The claim according to claim 25 where the communications circuitry uses Bluetooth.

28. The claim according to claim 25 where the switches are tactile switches.

29. The claim according to claim 25 where the switches are magnetic switches.

30. The claim according to claim 25 where the switches are photoresistor switches.
